(19) United States
(12) Patent Application Publication
(10) Pub. No.: US 2026/0340764 A1
(43) Pub. Date: Oct. 29, 2026

(54) METHOD FOR GENERATING A SECONDARY IMAGE FROM A PRIMARY IMAGE

(71) Applicant: Robert Bosch GmbH, Stuttgart (DE)

(72) Inventors: Fabian Gigengack, Hemmingen (DE); Eashwara Sudharsan Erahan, Hildesheim (DE); Simon Roesler, Hildesheim (DE)

(21) Appl. No.: 19/648,505

(22) Filed: Apr. 15, 2026

(30) Foreign Application Priority Data
Apr. 29, 2025 (DE) 10 2025 116 411.8

(51) Int. Cl. G06T 3/40

(52) U.S. Cl. CPC G06T 3/40

(57) ABSTRACT

A method for generating a secondary image from a primary image, which has primary pixels. In the method, for generating the secondary image, the primary pixels are sampled and represented in secondary pixels of the secondary image. The sampling rate is increased in at least one zoom region. A computer program product for performing the method is also described.

### FIELD

The present disclosure relates to a method for generating a secondary image from a primary image. The present disclosure also relates to a computer program product for performing the method.

### BACKGROUND INFORMATION

Cameras and images originating therefrom serve a variety of purposes. For example, the images supplied by cameras can serve for monitoring and inspecting the surrounding area, including recognizing objects in the surrounding area.

Such cameras ordinarily supply, in particular due to their design, images in which the near surrounding area of the camera is represented with a greater number of pixels than the more distant surrounding area of the camera. This can be disadvantageous for evaluation of the images.

In order to compensate for such disadvantages, so-called “virtual zooming” can be used in order to generate secondary images from images originating from the camera, also referred to below as primary images.

Such virtual zooming is described, for example, in the following publications:
C. Thavamani, M. Li, N. Cebron, and D. Ramanan, “Fovea: Foveated image magnification for autonomous navigation” in ICCV, 2021.
C. Thavamani, M. Li, F. Ferroni, and D. Ramanan, “Learning to zoom and unzoom”, 2023.
A. Ghosh, N. D. Reddy, C. Mertz, and S. G. Narasimhan, “Learned two-plane perspective prior based image resampling for efficient object detection”, 2023.

The methods described in the related art for generating secondary images from primary images result in increased computational complexity.

### SUMMARY

It is an object of the present disclosure to specify improved or at least alternative embodiments for a method for generating a secondary image from a primary image of the aforementioned type and for a computer program product for performing the method.

The object may be achieved by certain features of the present disclosure. Advantageous variants are disclosed herein.

According to an example embodiment, a main feature of the present disclosure is that, for generating a secondary image from a primary image, pixels of the primary image are sampled with different sampling rates and represented in the secondary image in order to represent and display at least one region of the primary image enlarged in the secondary image. Thus, “virtual zooming” only regionally of the primary image is simplified in the secondary image and is thus implemented with reduced computational load.

The main feature is implemented in a method for generating a secondary image from a primary image. The primary image has pixels, which are also referred to below as “primary pixels”. For generating the secondary image, the primary pixels are sampled and represented in pixels of the secondary image, which are also referred to below as “secondary pixels”. The sampling rate is increased in at least one region of the primary image, in particular selected to be higher than in another region, so that the region having the increased sampling rate is represented enlarged in the secondary image. The at least one region having an increased sampling rate is also referred to below as a “zoom region”.

By means of the method, in particular by means of the increased sampling rate, virtual zooming is thus carried out in particular in the at least one zoom region.

Preferably, the relevant at least one zoom region is predetermined and/or specified in advance.

The method described herein is expediently a computer-implemented method.

The method is preferably implemented by means of a computer program product.

The computer program product comprises instructions that, upon execution of the computer program product by a computer, cause the computer to perform the method of the present disclosure.

It is understood that the computer program product also belongs to the scope of this disclosure.

It is understood that, by means of the method described herein, a plurality of secondary images can also be generated from a plurality of primary images. A corresponding secondary image is preferably generated for the particular primary image.

The primary image expediently originates from a camera.

The camera can be one of any type. For example, the primary image can originate from a pinhole camera or a so-called “cylindrical camera”.

The secondary image, in particular the secondary images, can be reused and/or further processed as desired.

The relevant secondary image can be used, for example, in a system in order to inspect and/or monitor the surrounding area, in particular also to recognize objects in the surrounding area.

In particular, it is possible to use the relevant secondary image for supporting and/or operating a vehicle assistance system. By means of the vehicle assistance system, it is possible, for example, to drive the vehicle at least partially autonomously.

The method according to the present disclosure in particular makes it possible to ascertain the real position of objects by means of the secondary image. Simplified and improved monitoring and inspection of the surrounding area, in particular also simplified and improved recognition of objects, are carried out in the at least one zoom region, in particular in comparison with the primary image.

The increased sampling rate in the at least one zoom region means that the sampling rate in at least one other region of the primary image is smaller than the sampling rate in the zoom region.

It is possible that the sampling rate outside the at least one zoom region is constant.

It is also possible that the sampling rate is reduced in at least one region of the primary image different from the zoom region, wherein the region is also referred to below as an “auxiliary region”. Thus, the at least one auxiliary region is represented reduced in the secondary image.

Advantageous example embodiments are those in which the sampling rate in the at least one zoom region is increased in comparison with a constant sampling rate and is reduced in the at least one auxiliary region in comparison with the constant sampling rate.

In principle, the secondary image can have more secondary pixels than the primary image has primary pixels.

In preferred example embodiments, the sampling rate is selected and/or varied in such a way that the number of secondary pixels is at most as large as the number of primary pixels. This means in particular that the sampling rate in the at least one zoom region and in the at least one auxiliary region are selected in such a way that the number of secondary pixels is at most as large as the number of primary pixels. Preferably, the sampling rate is selected and/or varied in such a way that the number of secondary pixels is smaller than the number of primary pixels. Thus, the expenditure for generating the secondary image is reduced. Moreover, the memory requirement for the secondary image is thus at most as large as, preferably smaller than, the memory requirement for the primary image.

Selection of the at least one zoom region, in particular additionally selection of the at least one auxiliary region, is preferably carried out based on geometric conditions.

If, for example, it is known that regions of interest in the surrounding area are, due to geometry, arranged in specific regions in the primary image, these regions are selected as zoom regions.

In preferred variants, the sampling rate is varied along a specified direction of the primary image. By means of the direction, the geometric condition described above is in particular taken into consideration. Correspondingly, the direction is selected.

The direction can correspond to the vertical direction.

The sampling rate can be varied along the direction in such a way that, along the direction, at least one zoom region is arranged between at least two auxiliary regions. Thus, it is in particular taken into consideration that, along the direction, at least one region of increased interest is arranged between at least two regions of reduced interest.

This can occur, for example, along the vertical direction, wherein, in the primary image, the vertically central region is of increased interest and is thus intended to be represented enlarged in the secondary image, whereas the vertically upper and lower regions of the primary image are of less interest and are thus intended to be represented reduced in the secondary image. Accordingly, embodiments are preferred in which the direction corresponds to the vertical direction in the primary image, so that a vertically central region of the primary image corresponds to at least one zoom region and vertically lateral regions of the primary image in each case correspond to at least one auxiliary region. In this case, the sampling rate thus increases in the vertical direction toward the vertically central region of the primary image and decreases vertically upward and downward proceeding from the central region.

Variation of the sampling rate is preferably steady. This in particular enables a simplified further use of the secondary image.

In preferred variants, the sampling rate is varied according to a function, so that the sampling rate is increased in the at least one zoom region, in particular additionally reduced in the at least one auxiliary region. Thus, the function is selected in such a way that it assumes increased absolute values in the at least one zoom region. Moreover, the function is preferably selected in such a way that it assumes reduced absolute values in the at least one auxiliary region.

The function can also be referred to as a zoom function.

In particular, the zoom function is applied to the specified direction, for example to the vertical direction. This means that the zoom function causes the sampling rate to vary along the specified direction, in particular along the vertical direction.

In preferred example embodiments, the function is invertible. Thus, viewing rays can be derived from the secondary image and the real surrounding area can thus be reconstructed. Thus, this in particular allows the real spatial surrounding area of the primary image, in particular of the camera from which the primary image originates, to be reconstructed reliably and in simplified form. Thus, it is in particular possible to inspect and/or monitor the surrounding area in simplified form and with increased reliability.

The function can be one of any type.

Reduced computational load, in particular additionally an invertible property of the function, is advantageously achieved in that a trigonometric function is selected as the function.

Advantageously, the function contains a normalization factor. The normalization factor can be advantageous in order to control the so-called field of view. This means in particular that the normalization factor can be applied to the trigonometric function.

In preferred example embodiments, the function is selected in such a way that the sampling rate along the direction, in particular along the vertical direction, transitions from a concave profile into a convex profile or vice versa.

For example, in particular in the case of a pinhole camera, a hyperbolic sine can be selected as the function or the function can contain the hyperbolic sine.

Further important features and advantages of the present disclosure can be found herein.

It is self-evident that the features mentioned above and those still to be explained below can be used not only in the combination specified in each case but also in other combinations or alone, without departing from the scope of the present disclosure.

Preferred exemplary embodiments of the present disclosure are illustrated in the figures and are explained in more detail in the following description, wherein the same reference signs refer to identical or similar or functionally identical components.

### BRIEF DESCRIPTION OF THE DRAWINGS

FIG. 1 is a simplified grid-like representation of a primary image.

FIG. 2 is a simplified grid-like representation of a secondary image, according to an example embodiment.

FIG. 3 is a highly simplified side representation of a camera in a vehicle/FIG. 4 shows a diagram for explaining generation of the secondary image, according to an example embodiment.

### DETAILED DESCRIPTION OF EXAMPLE EMBODIMENTS

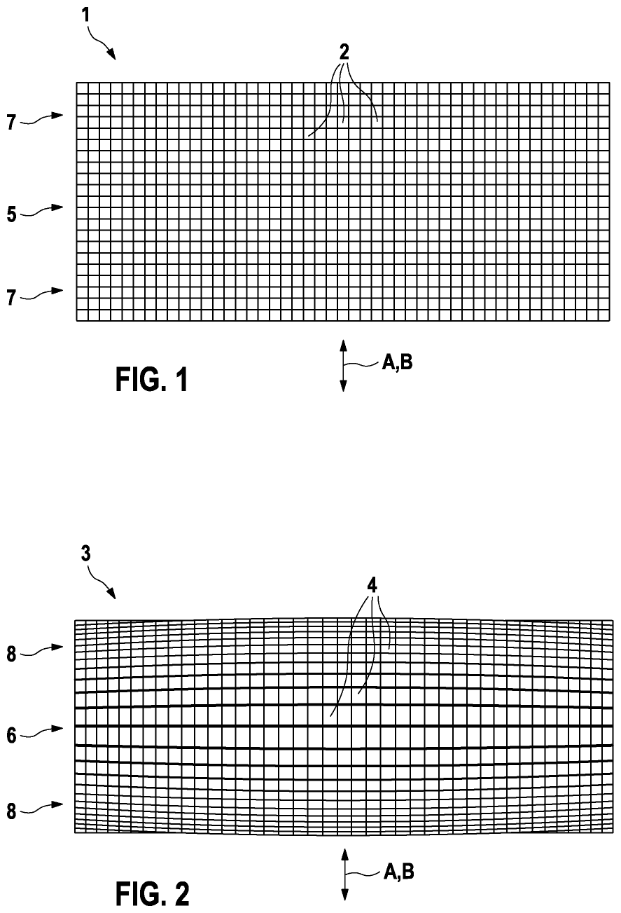

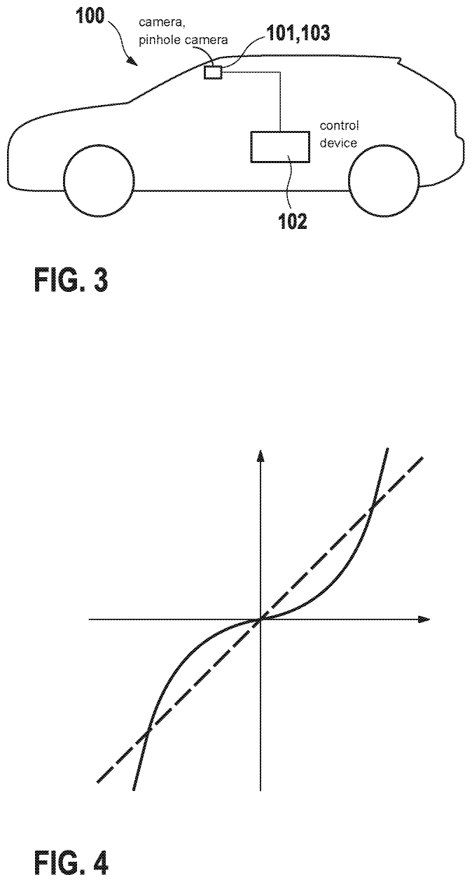

An image 1 shown highly simplified in FIG. 1 can originate from a camera 101 shown highly simplified in FIG. 3. The camera 101 can be positioned in a vehicle 100, in particular be a component of the vehicle 100, in order to inspect and monitor the surrounding area of the vehicle 100, in particular to recognize objects not shown in the surrounding area of the vehicle 100. The image 1 is also referred to below as “primary image” 1. Such primary images 1 are generated continuously/regularly by means of the camera 101.

In FIG. 1, the primary image 1 is shown in grid-like form, wherein the size of the individual grid elements 2 symbolizes the represented size of the region (not shown) of the surrounding area represented in the associated grid element 2. As can be gathered from FIG. 1, the grid elements 2 of the primary image 1 have constant sizes. This means that, in the primary image 1 of the exemplary embodiment shown, all regions are represented with the same size.

FIG. 2 shows an image 3 that was generated from the primary image 1 according to the method described below. The image 3 is also referred to below as “secondary image” 3. In FIG. 2, the secondary image 3, analogously to the representation of the primary image 1 in FIG. 1, is shown in grid-like form, wherein the size of the individual grid elements 4 symbolizes the represented size of the associated region of the surrounding area represented in the associated grid element 4. As can be gathered from FIG. 2, grid elements 4 of different size exist in the secondary image 2. This means that the secondary image 2 represents certain regions of the surrounding area enlarged. This means that zooming is carried out with the secondary image 2 in the enlarged represented regions.

For generating the secondary image 2, pixels (not shown) of the primary image 1 are sampled and represented in pixels (not shown) of the secondary image 3. The pixels of the primary image 1 are also referred to below as “primary pixels” and the pixels of the secondary image 3 are also referred to as “secondary pixels”. For generating the secondary image 2, the primary pixels are thus sampled and represented in secondary pixels of the secondary image 4. A sampling rate of the sampling is increased in at least one region 5 of the primary image 1, i.e., selected to be higher, so that the at least one region 5 is represented enlarged in the secondary image 4. The region 5 is also referred to below as “zoom region” 5. The representation of the zoom region 5 is indicated in the secondary image 3 as represented zoom region 6.

The sampling rate can additionally be reduced in at least one region 7 of the primary image 1 different from the zoom region 5, i.e., selected to be reduced, so that the region 7 is represented reduced in the secondary image 3. The region 7 is also referred to below as the “auxiliary region” 7. The representation of the auxiliary region 7 is indicated in the secondary image 3 as represented auxiliary region 8.

In the exemplary embodiment shown, the sampling rate is varied along a specified direction A, which in the exemplary embodiment shown is the vertical direction B. In the exemplary embodiment shown, it is assumed that a zoom region 5 is arranged along the direction A between one auxiliary region 6 in each case, i.e., between two auxiliary regions 6. As can be gathered from FIG. 2, the size of the grid elements 4 in the secondary image 3 decreases and increases continuously and/or steadily along the direction A. This means that the sampling rate decreases and increases continuously and/or steadily along the direction A.

As indicated in FIG. 4, the sampling rate is preferably varied according to a function z, so that the sampling rate is increased in the at least one zoom region 5 and reduced in the at least one auxiliary region 7. The function z is also referred to below as “zoom function.” The zoom function z is advantageously invertible. In the exemplary embodiment shown in FIG. 4, the zoom function z is a trigonometric function or a function comprising a trigonometric function. In FIG. 4, the zoom function z is shown with a solid line. A dashed line indicates the profile of the sampling rate along the direction A in the case of an identical representation of the primary image 1 in the secondary image 3.

As can be gathered from FIG. 4, the zoom function z transitions along the direction A from a concave profile into a convex profile. In the exemplary embodiment shown, the zoom function z is a hyperbolic sine, which can be normalized.

The method is preferably carried out by means of a computer program product comprising corresponding instructions. Upon execution by a computer (not shown), these instructions cause the computer to perform the method.

The method can be carried out in a control device 102 of the vehicle 100, which is correspondingly connected to the camera 101. The control device 102 can at least partially comprise the computer mentioned above.

The method is explained below by way of example, wherein it is assumed purely by way of example that the camera 101 is a pinhole camera 103.

Assuming that K is an intrinsic matrix of the pinhole camera 103, a point \vec{X}∈ [symbol] of the surrounding area can be projected into the pinhole camera by means of the matrix Kas follows:

\vec{u}≅\vec{p}=K\vec{X}

\vec{p} corresponds to the projection and u corresponds to the pixel coordinates of a primary pixel, in particular after normalization of homogeneous coordinates.

A primary pixel \vec{u} can be “reprojected” into a viewing ray \vec{r} by means of the inverse of the matrix:

$$\vec{r} = {\underline{K}}^{- 1} [ \begin{matrix}\vec{u} \\ 1\end{matrix} ]$$

The zoom function z corresponds to:

z: [symbol] →

[symbol]

As mentioned above, an invertible trigonometric function, namely the hyperbolic sine, is selected as the zoom function z in the exemplary embodiments shown:

z(x):=sinh(f_{zoom}x)

A normalization factor form can serve for improved control of the field of view:

z(x):=sinh(f_{zoom}x)fₙₒᵣₘ

Thus, the inverse of the zoom function z is:

$${z}^{- 1} ( x ) := \frac{{sinh}^{- 1} ( \frac{x}{{f}_{norm}} )}{{f}_{zoom}}$$

Upon applying this zoom function to the vertical direction B, the following results:

$${\vec{r}}_{zoom} = [ \begin{matrix}{r}_{x} \\ z ( {r}_{y} ) \\ {r}_{z}\end{matrix} ]$$

rₓ, r_{y} and r_{z} are the corresponding dimensions of \vec{r}.

Since z is invertible, the following applies for the inverse:

$${\vec{u}}_{zoom} ≅ [ \begin{matrix}{p}_{u} \\ {z}^{- 1} ( {p}_{v} ) \\ {p}_{w}\end{matrix} ]$$

wherein pᵤ, p_{y} and p_{w} are the corresponding components of \vec{p}.

1-11. (canceled)

12. A method for generating a secondary image having secondary pixels from a primary image, wherein the primary image has primary pixels, the method comprising:
generating the secondary image by:
sampling the primary pixels and representing the sampled primary pixels in secondary pixels of the secondary image;
wherein a sampling rate of the sampling is increased in at least one zoom region of the primary image, so that the at least one zoom region is represented enlarged in the secondary image.

13. The method according to claim 12, wherein the sampling rate in the at least one zoom region is increased in comparison with a constant sampling rate and is reduced in at least one auxiliary region of the primary image different from the zoom region in comparison with the constant sampling rate, so that the at least one auxiliary region is represented reduced in the secondary image.

14. The method according to claim 13, wherein the sampling rate in the at least one zoom region and in the at least one auxiliary region is selected in such a way that a number of secondary pixels is at most as large as a number of the primary pixels.

15. The method according to claim 13, wherein the sampling rate is varied along a specified direction of the primary image.

16. The method according to claim 15, wherein the sampling rate is varied in such a way that, along the specified direction, at least one zoom region is arranged between at least two auxiliary regions.

17. The method according to claim 16, wherein the specified direction corresponds to a vertical direction in the primary image, so that a vertically central region of the primary image corresponds to at least one zoom region and vertically lateral regions of the primary image each correspond to at least one auxiliary region.

18. The method according to claim 13, wherein the sampling rate is varied according to a function, so that the sampling rate is increased in the at least one zoom region and is reduced in the at least one auxiliary region.

19. The method according to claim 18, wherein the function is invertible, so that viewing rays can be ascertained from the secondary image.

20. The method according to claim 18, wherein the function is a trigonometric function.

21. The method according to claim 16, wherein the sampling rate is varied according to a function, so that the sampling rate is increased in the at least one zoom region and is reduced in the at least one auxiliary region, and wherein the function is selected in such a way that the sampling rate along the specified direction transitions from a concave profile into a convex profile, or vice versa.

22. A non-transitory computer-readable medium on which is stored a computer program including instructions for generating a secondary image having secondary pixels from a primary image, wherein the primary image has primary pixels, the instructions, when executed by a computer, causing the computer to perform steps comprising:
generating the secondary image by:
sampling the primary pixels and representing the sampled primary pixels in secondary pixels of the secondary image;
wherein a sampling rate of the sampling is increased in at least one zoom region of the primary image, so that the at least one zoom region is represented enlarged in the secondary image.
